(19) United States
(12) Patent Application Publication
(10) Pub. No.: US 2014/0261799 A1
(43) Pub. Date: Sep. 18, 2014

(54) SIMPLIFIED LIQUID OUTLET VALVES, PUMPS AND REFILL UNITS

(71) Applicants: Nick E. Ciavarella, Seven Hills, OH (US); Robert L. Quinlan, Stow, OH (US); Christopher J. Mann, Cuyahoga Falls, OH (US); John J. McNulty, Broadview Heights, OH (US)

(72) Inventors: Nick E. Ciavarella, Seven Hills, OH (US); Robert L. Quinlan, Stow, OH (US); Christopher J. Mann, Cuyahoga Falls, OH (US); John J. McNulty, Broadview Heights, OH (US)

(73) Assignee: GOJO Industries, Inc., Akron, OH (US)

(21) Appl. No.: 13/830,565

(22) Filed: Mar. 14, 2013

(51) Int. Cl. B67D 3/00

(52) U.S. Cl. CPC B67D 3/0019
USPC 137/565.01

(57) ABSTRACT

Exemplary simplified outlet valves, pumps and refill units are disclosed herein. An exemplary inverted refill unit for a dispenser includes a container and a pump secured to the bottom of container. The pump has a liquid inlet valve and a liquid outlet having an annular housing. One or more liquid outlet passages are located within the annular housing. A valve seat is located proximate the liquid outlet passages. A liquid outlet valve is also included. The liquid outlet valve includes an annular body and a resilient disc located on the interior of the annular body. The resilient disc has an opening in the center and seals against the valve seat to seal the one or more liquid outlet passages in a normal state. The resilient disc deflects from the valve seat under pressure so that liquid flows through the liquid outlet passages and through the center of the resilient disc.

### TECHNICAL FIELD

The present invention relates generally to liquid outlet valves, pumps and refill units.

### BACKGROUND OF THE INVENTION

Dispensers having inverted refill units, i.e. refill units that have a container full of liquid and a pump located below the container, are generally configured to provide a user with an amount of soap or sanitizer upon actuation of the dispenser. The inverted dispensers may be liquid dispensers or foam dispensers. Inverted foam dispensers generally convert liquid material, such as liquid soap or sanitizer, into foam by aerating the liquid material as it is dispensed. Air is generally injected into the liquid material to form air bubbles in the liquid, causing the formation of foam. Inverted foam dispensers may include a replaceable refill container that is replaced after the liquid material therein is consumed by the user. Liquid outlet valves for inverted dispensers are known. Many prior art liquid outlet valves include springs.

### SUMMARY

Exemplary simplified outlet valves, pumps and refill units utilizing such simplified outlet valves are disclosed herein. An exemplary inverted refill unit for a dispenser includes a container and a pump secured to the bottom of container. The pump has a liquid inlet valve and a liquid outlet having an annular housing. One or more liquid outlet passages are located within the annular housing. A valve seat is located proximate the liquid outlet passages. A liquid outlet valve is also included. The liquid outlet valve includes an annular body and a resilient disc located on the interior of the annular body. The resilient disc has an opening in the center and seals against the valve seat to seal the one or more liquid outlet passages in a normal state. The resilient disc deflects from the valve seat under pressure so that liquid flows through the liquid outlet passages and through the center of the resilient disc.

Another exemplary inverted refill unit for a dispenser includes a container and a pump secured to the bottom of container. The pump has a liquid inlet valve and a liquid outlet having an annular housing with one or more liquid outlet passages therethrough and a liquid outlet valve. The liquid outlet valve has a resilient disc that has an outside located on the interior of the annular body. The resilient disc has an opening in the center. The resilient disc is angled upward. In addition, the liquid outlet valve is normally closed sealing off the liquid passages.

Another exemplary inverted refill unit for a dispenser includes a container and a pump secured to the bottom of container. The pump has a liquid inlet valve and a liquid outlet having an annular housing that includes one or more liquid outlet passages therethrough, and a liquid outlet valve. The liquid outlet valve includes a resilient disc that has an opening in the center. In addition, the liquid outlet valve has a plurality of feet located below the resilient disc.

### BRIEF DESCRIPTION OF THE DRAWINGS

These and other features and advantages of the present invention will become better understood with regard to the following description and accompanying drawings in which:

FIG. 1 is an cross-section of an exemplary refill unit for a foam pump having a simplified outlet valve;

FIG. 2 is a plan view of an exemplary simplified liquid outlet valve for a pump used in an inverted refill unit of FIGS. 1 and 6;

FIG. 3 is a cross-section of the exemplary simplified liquid outlet valve of FIG. 2;

FIG. 4 is an enlarged cross-section of a portion of the foam pump and the simplified liquid outlet valve of FIG. 1 with the simplified liquid outlet valve in a open position;

FIG. 5 FIG. 4 is an enlarged cross-section of a portion of the foam pump and the simplified liquid outlet valve of FIG. 1 with the simplified liquid outlet valve in a open position; and

FIG. 6 is a cross-section of an exemplary refill unit having a liquid pump with a simplified outlet valve.

### DETAILED DESCRIPTION

FIG. 1 illustrates an exemplary refill unit 110. Refill unit 110 includes a container 112 and a foam pump 130. Foam pump 130 includes a pump housing 102 is secured to a neck 101 of container 112 by collar 104. Collar 104 is secured to container 112 by a snap-fit connection; however, it could be connected by any means, such as, for example a threaded connection, a welded connection, an adhesive connection or the like.

Located between pump housing 102 and container neck 101 is plate 106. Plate 106 includes an aperture 107 surrounded above by valve seat 108 which provides a seat for inlet ball valve 111. Inlet ball valve 111 is retained from below by anchors 109 which are secured to plate 106. Inlet ball valve 111 is a normally open valve. Accordingly, liquid may flow past the inlet ball valve 111 into liquid inlet channel 113, past sleeve 114 and into liquid pump chamber 116.

When liquid pump chamber 116 is pressurized, as discussed in detail below, inlet ball valve 111 seals against seat 108 to prevent liquid from flowing from pump chamber 116 back into container 112. In some embodiments, ball valve 111 may be a normally closed valve and in that case may include a biasing member (not shown) to bias the ball valve 111 closed. In addition, although the one-way liquid inlet valve is a ball valve, other types of one-way inlet valves may be used, such as, for example, a mushroom valve, an umbrella valve, a poppet valve, a flapper valve, or the like.

Pump housing 102 includes a cavity 113. Located within cavity 113 is a sleeve 114. A liquid piston 118 moves in a back and forth reciprocating motion within sleeve 114 to increase and decrease the volume of pump chamber 116. Similarly, located within cavity 113 is an air piston sleeve 153. Air piston 152 moves in a back and forth reciprocating motion within air piston sleeve 153 to increase and decrease the volume of air chamber 150. Sleeves 114 and 153 are manufactured with tight tolerances and allow pump housing 102 to be manufactured inexpensively without tight tolerances.

The liquid piston 118 is connected to liquid piston stem 119. Liquid piston stem 119 is connected to air piston 152. Accordingly, movement of air piston 152 also moves liquid piston 118. Air piston 152 also includes connector 154. Connector 154 mates with a connector (not shown) on a dispenser (not shown).

Pump housing 102 also includes one or more liquid outlet passages 127. Liquid outlet passages 127 are formed in pump housing 102 and extend from cavity 113 to the bottom of pump housing 102. Pump housing 102 includes annular projection 128 for connecting to lower pump housing 105. In addition, pump housing 102 includes an annular projection 410 (FIG. 4) which provides a valve seat for one-way liquid outlet valve 190.

The lower pump housing 105, of foam pump 130 that has an annular projection 107 for connecting to an annular outlet 157 of air chamber 150. In addition, lower pump housing 105 includes an outlet 130 and a seat 109. Lower pump housing 105 retains foaming cartridge 109 and valve 190. Seat 109 provides support for foaming cartridge 123 which contains one or more foaming screens 124. In addition, foaming cartridge 123 supports one-way liquid outlet valve 190.

FIGS. 2-3 provide a detailed view of one-way liquid outlet valve 190. One-way liquid outlet valve 190 is an elastomeric member that includes cylindrical side wall 202, resilient disc 204, opening 206 and a plurality of feet 203. Cylindrical side wall 202 fits over annular projection 402 (FIG. 4) of lower pump housing 102. In some embodiments, cylindrical wall 202 forms a tight fit with annular projection 402 and is securely held in place by the friction fit. In addition, as described above, feet 203 rest on foaming cartridge 123 to secure one-way outlet valve 190 in place.

Resilient disc 204 is flexible and is angled upward, or loaded with a deflection. Because one-way liquid outlet valve 190 is used in an inverted refill unit 110 one-way liquid outlet valve 190 needs to prevent static drip. Typically, elastomeric valves that deflect are only used for air and do not need to overcome static drip issues. Static drip occurs when the weight of the fluid in the container either opens the outlet valve or prevents the outlet valve from closing properly. In addition, the cracking pressure is important. If the cracking pressure is too high, the pump requires too much force to operate and would not be suitable for use in dispensers, particularly touch-free dispensers where the pump actuator is operated by battery power. These two designs considerations are in opposition to one another.

In one embodiment, the static drip consideration has been addressed by loading the resilient disc 204 with about 0.005 inches of deflection. In some embodiments, the resilient disc 204 is loaded with greater than about 0.003 inches of deflection. In some embodiments, the resilient disc 204 is loaded with between about 0.001 and 0.01 inches of deflection. Loading the resilient disc 204 with deflection prevents static drip. In addition, in some embodiments, the one-way liquid outlet valve opens at a pressure that is lower than about 3 psi (pounds per square inch), which is a standard dispenser pump operating pressure.

In some embodiments, outlet nozzle 130 is funnel shaped and, as foam flows through outlet nozzle 130 the velocity of the foam is increased helping to enrich the foam.

Located between air compressor chamber 150 and mixing chamber 404 is an air outlet passage 158. Air outlet passage 158 is elongated and located at the bottom of air chamber 150. In some embodiments, air outlet passage 158 includes a stepped down portion 159 where the air outlet passage 158 connects to lower pump housing 105. This stepped down portion may trap and retain residual foam and liquid that is sucked back into air chamber 150 as air piston 152 is moved back to its charged position.

In some embodiments, a one-way air inlet valve 156 is located in the body of air piston 153. In some embodiments, a one-way air inlet valve (not shown) is located in a wall of air piston sleeve 153. One-way air inlet valve 156 has a cracking pressure that is selected so that when air piston 152 is moved from a fully discharged position toward the fully primed or charged position air is drawn in through though the outlet nozzle 130 and sucks back residual foam and liquid up through air passages 128. As the air piston 152 moves toward its fully charged position, the vacuum pressure in air chamber 150 increases because of the resistance caused by the foaming screens and air passage 124. Once the vacuum pressure increases to a set point, the one-way air inlet valve 156 opens and allows air to flow into air chamber 150. In some embodiments, a cracking pressure of about 3 psi is selected. Thus, foam pump 130 provides for a limited suck back of foam and extends battery life because the one-way air inlet valve 156 allows air piston 152 to move back without the increased resistance of the screen(s) 124.

During operation, one-way liquid outlet valve 190 is normally closed as shown in FIG. 4. Resilient disc 204 seals against annular projection 410 of pump housing 102. To prime or charge foam pump 130, the liquid piston 118 and air piston 152 are moved outward, liquid flows from container 112 past one-way inlet ball valve 111 through passage 115 into the area defined by cavity 113 and sleeve 114 and into liquid pump chamber 116. Air is initially drawn in through outlet 130 and screens 124, which sucks back fluid and foam left in the foaming cartridge 123 and outlet 130. Then, air inlet valve 156 opens and allows air to freely flow into air chamber 150.

To discharge foam pump 130, the liquid piston 118 and air piston 152 are moved inward. Liquid is forced out of liquid pump chamber 116 through liquid outlet passages 127 and the pressure forces resilient disc 204 to deflect downward as illustrated in FIG. 5. Liquid flows past disk 204 and through opening 206 into mixing chamber 404. Air from air chamber 150 travels through air outlet 158 (picking up residual fluid sucked into the air chamber during priming) into mixing chamber 404 where the air and liquid mix together. The air/liquid mixture is forced through mixing cartridge 123 and dispensed as a foam.

FIG. 6 illustrates another exemplary refill unit 610. Refill unit 610 includes a container 612 and a liquid pump 630. Liquid pump 630 includes a pump housing 602 is secured to a neck 601 of container 612 by collar 604. Collar 604 is secured to container 612 by a snap-fit connection; however, it could be connected by any means, such as, for example a threaded connection, a welded connection, an adhesive connection or the like.

Located between pump housing 602 and container neck 601 is plate 606. Plate 606 includes an aperture 607 surrounded above by valve seat 608 which provides a seat for inlet ball valve 611. Inlet ball valve 611 is retained from below by anchors 609 which are secured to plate 606. Inlet ball valve 611 is a normally open valve. Accordingly, liquid may flow past the inlet ball valve 610 into liquid inlet channel 615, past sleeve 614 and into liquid pump chamber 616.

When liquid pump chamber 616 is pressurized, as discussed in detail below, inlet ball valve 611 seals against seat 608 to prevent liquid from flowing from pump chamber 616 back into container 612. In some embodiments, ball valve 611 may be a normally closed valve and in that case may include a biasing member (not shown) to bias the ball valve 611 closed. In addition, although the one-way liquid inlet valve 611 is a ball valve, other types of one-way inlet valves may be used, such as, for example, a mushroom valve, an umbrella valve, a poppet valve, a flapper valve or the like.

Pump housing 602 includes a cavity 613. Located within cavity 613 is a sleeve 614. A liquid piston 618 moves in a back and forth reciprocating motion within sleeve 614 to increase and decrease the volume of pump chamber 616. Sleeve 614 is manufactured with tight tolerances and allows pump housing 602 to be manufactured inexpensively without tight tolerances.

The liquid piston 118 is connected to liquid piston stem 619 and includes a connector 654 that mates with a connector (not shown) on a dispenser (not shown). Pump housing 602 also includes one or more liquid outlet passages 627. Liquid outlet passages 627 are formed in pump housing 602 and extend from cavity 613 to the bottom of pump housing 602. Pump housing 602 includes annular projection 628 for connecting to lower pump housing 605. In addition, pump housing includes an annular projection 610 (FIG. 4) which provides a valve seat for one-way liquid outlet valve 190, which is the same liquid outlet valve described above with respect to foam pump 130. Liquid outlet valve 190 operates in the same manner described above and is not re-described with respect to liquid pump 630.

Liquid pump 630 includes a lower pump housing 605 that has a seat 609. Lower pump housing 105 and seat 109 provides support for one-way liquid outlet valve 190.

As described above, during operation, one-way liquid outlet valve 190 is normally closed as shown in FIG. 4. Resilient disc 204 seals against annular projection 610 of pump housing 602. To prime or charge liquid pump 130, the liquid piston 118 is moved outward, liquid flows from container 112 past one-way inlet ball valve 111 through passage 115 into the area defined by cavity 113 and sleeve 114 and into liquid pump chamber 116.

To discharge liquid pump 130, the liquid piston 118 is moved inward. Liquid is forced out of liquid pump chamber 116 through liquid outlet passages 127 and the pressure forces resilient disc 204 to deflect downward as illustrated in FIG. 5. Liquid flows past disk 204 and through opening 206 and out of outlet 630.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. It is not the intention of the applicant to restrict or in any way limit the scope of the appended claims to such detail. Unless expressly excluded herein, all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order in which the steps are presented to be construed as required or necessary unless expressly so stated.

We claim:

1. An inverted refill unit for a dispenser comprising:
a container;
a pump secured to the bottom of container;
the pump having
a liquid inlet valve;
a pump chamber;
a liquid outlet having an annular housing, with one or more liquid outlet passages located within the annular housing;
a valve seat located proximate the liquid outlet passages; and
a liquid outlet valve;
the liquid outlet valve having
an annular body,
a resilient disc located on the interior of the annular body;
the resilient disc having an opening in the center;
the resilient disc sealing against the valve seat to seal the one or more liquid outlet passages in a normal state; and
the disc deflecting from the valve seat under pressure so that liquid flows through the liquid outlet passages and through the center of the resilient disc.

2. The inverted refill unit for a dispenser of claim 1 further comprising a plurality of feet located below the resilient disc.

3. The inverted refill unit for a dispenser of claim 1 wherein the resilient disc is loaded with deflection such that the resilient disc angles upward to contact the pump housing to seal off the liquid outlet passages.

4. The inverted refill unit for a dispenser of claim 3 wherein the resilient disc is loaded with about 0.005 inches of deflection.

5. An inverted refill unit for a dispenser comprising:
a container;
a pump secured to the bottom of container;
the pump having
a liquid inlet valve;
a pump chamber;
a liquid outlet having an annular housing with one or more liquid outlet passages therethrough; and
a liquid outlet valve;
the liquid outlet valve having
a resilient disc having an outside located on the interior of the annular body;
the resilient disc having an opening in the center;
the resilient disc angled upward; and
the liquid outlet valve is normally closed sealing off the liquid passages.

6. The inverted refill unit of claim 1 wherein the resilient disc is loaded with between about 0.001 and 0.010 inches of deflection.

7. The inverted refill unit of claim 1 wherein the resilient disc is loaded with greater than about 0.003 inches of deflection.

8. The inverted refill unit of claim 1 wherein the resilient disc is loaded with about 0.005 inches of deflection.

9. The inverted refill unit of claim 1 wherein the resilient disc has a cracking pressure of less than about 3 pounds per square inch.

10. The inverted refill unit of claim 1 further comprising an air compressor and a mixing chamber, wherein the liquid outlet valve places the one or more liquid outlet passages in fluid communication with the mixing chamber when the liquid outlet valve is open.

11. The inverted refill unit of claim 1 further comprising a liquid in the container.

12. An inverted refill unit for a dispenser comprising:
a container;
a pump secured to the bottom of container;
the pump having
a liquid inlet valve;
a pump chamber;
a liquid outlet having an annular housing, with one or more liquid outlet passages therethrough; and
a liquid outlet valve;
the liquid outlet valve having,
a resilient disc;
the resilient disc having an opening in the center; and
a plurality of feet located below the resilient disc.

13. The inverted refill unit of claim 12 further comprising a mixing chamber, wherein the plurality of feet form at least a portion of the mixing chamber.

14. The inverted refill unit of claim 12 wherein the feet support the liquid outlet valve.

15. The inverted refill unit of claim 12 wherein the liquid outlet valve further comprises an annular body.

16. The inverted refill unit of claim 15 wherein the annular body secures the liquid outlet valve to the pump.

17. The inverted refill unit of claim 12 wherein the resilient disc is loaded with between about 0.001 and 0.010 inches of deflection.

18. The inverted refill unit of claim 12 wherein the resilient disc is loaded with greater than about 0.003 inches of deflection.

19. The inverted refill unit of claim 12 wherein the resilient disc is loaded with about 0.005 inches of deflection.

20. The inverted refill unit of claim 12 wherein the resilient disc has a cracking pressure of less than about 3 pounds per square inch.
